(19) United States
(12) Patent Application Publication
(10) Pub. No.: US 2014/0083452 A1
(43) Pub. Date: Mar. 27, 2014

(54) METHOD FOR IN SITU CLEANING OF MOCVD REACTION CHAMBER

(71) Applicant: Advanced Micro-Fabrication Equipment Inc, Shanghai, Shanghai (CN)

(72) Inventors: Gerald Zheyao Yin, Shanghai (CN); Zhiyou Du, Shanghai (CN); Shuang Meng, Shanghai (CN); Yang Wang, Shanghai (CN); Ying Zhang, Shanghai (CN)

(73) Assignee: Advanced Micro-Fabrication Equipment Inc, Shanghai, Shanghai (CN)

(21) Appl. No.: 14/032,130

(22) Filed: Sep. 19, 2013

(30) Foreign Application Priority Data
Sep. 26, 2012 (CN) 201210365205.0

(51) Int. Cl. B08B 9/08

(52) U.S. Cl. CPC B08B 9/08
USPC 134/1.1

(57) ABSTRACT

The present invention provides a method for in situ cleaning of an MOCVD reaction chamber. The method includes: maintaining the internal pressure of the MOCVD reaction chamber in a predetermined pressure range, and keeping a plasma inside the MOCVD reaction chamber for a predetermined time period to completely remove deposits inside the MOCVD reaction chamber. The method for in situ cleaning of an MOCVD reaction chamber according to the embodiments of the present invention may remove relatively stable organic ligands or related polymers, resulting in a good cleaning effect for the removal of the deposits on the surfaces with a relatively low temperature inside the MOCVD reaction chamber.

### CROSS REFERENCE TO RELATED APPLICATION

This application claims the benefit of priority to Chinese Patent Application No.201210365205.0, entitled “METHOD FOR IN SITU CLEANING OF MOCVD REACTION CHAMBER”, filed on Sep. 26, 2012 with State Intellectual Property Office of PRC, which is incorporated herein by reference in its entirety.

### FIELD OF THE INVENTION

The present invention relates to semiconductor manufacture, and in particular, to a method for in situ cleaning of a Metal-Organic Chemical Vapor Deposition (MOCVD) reaction chamber.

### BACKGROUND OF THE INVENTION

At present, the MOCVD (Metal-Organic Chemical Vapor Deposition) technology is widely used in preparing compound of Group III element(s) and Group V element(s) (such as GaN, InN, AN, InGaN, AlGaN and GaP). In the state of the art, in an MOCVD reaction chamber for the preparation of the compound of the Group III element(s) and the Group V element(s), there is a main problem that extra solid by-product deposits (such as carbonaceous organic substances or metal and its compound(s)) may be generated inside the reaction chamber after each reaction step. These deposits are deposited inside the reaction chamber (for example, at a shower head, a susceptor and an inner wall), resulting in process drift and degraded performance. Moreover, impurities such as particulates are prone to be formed on a surface of a substrate during the preparation of the compound of the Group III element(s) and the Group V element(s), and these impurities may affect subsequent processes. Therefore, the MOCVD reaction chamber needs to be cleaned when being used, to remove the deposits inside the reaction chamber and to improve the quality of the prepared compound of the Group III element(s) and the Group V element(s).

In the prior art, the deposits inside the MOCVD reaction chamber are generally removed manually. Specifically, the MOCVD reaction chamber is opened, and then the deposits at the shower head and so on are removed manually. However, for the manual removal, the productivity is low, the repeatability is poor, and the cleaning efficiency is not high. For this reason, some methods for in situ removal of the deposits inside the MOCVD reaction chamber are proposed in the prior art. In these methods, the gas containing halide(s) (such as Cl₂, HCl and HBr) is introduced into the MOCVD reaction chamber to remove the deposits in situ. For this kind of cleaning method, the MOCVD reaction chamber does not need to be opened, the repeatability is good, the cleaning efficiency is high and the productivity is high.

However, on the surfaces with a relatively low temperature (for example, the surface of the shower head undergone water cooling, or the surface of the inner wall of the reaction chamber), precursors of metal organic compound are decomposed incompletely and form extra deposits. These extra deposits mainly contain relatively stable organic ligands or related polymers and metal and its compound(s). These relatively stable organic ligands or related polymers are mainly highly concentrated carbonaceous organic substances. In this case, this kind of in situ cleaning based on the simple halide(s) (such as Cl₂, HCl and HBr) has no effect for the removal of the deposits on the surfaces with a relatively low temperature.

### SUMMARY OF THE INVENTION

For the capability of removing deposits on the surfaces with a relatively low temperature inside an MOCVD reaction chamber, the present invention provides a method for in situ cleaning of the deposits inside the MOCVD reaction chamber. The method includes:

maintaining an internal pressure of the MOCVD reaction chamber in a predetermined pressure range, and keeping a plasma inside the MOCVD reaction chamber for a predetermined time period to completely remove the deposits inside the MOCVD reaction chamber, wherein the plasma is generated by the following steps:

introducing a cleaning gas into the MOCVD reaction chamber, and converting the cleaning gas into the plasma inside the MOCVD reaction chamber; and/or

converting the cleaning gas into the plasma outside the MOCVD reaction chamber, and introducing the plasma into the MOCVD reaction chamber;

wherein the cleaning gas includes an oxygen-containing gas and a halogen-containing gas.

Preferably, the cleaning gas further includes Ar.

Preferably, the method further includes:

during the predetermined time period, heating the MOCVD reaction chamber such that an internal temperature of the MOCVD reaction chamber is maintained in a range of 70° C. -80° C.

Preferably, the oxygen-containing gas includes one of O₂, O₃, CO₂, CO, H₂O₂, N₂O or any combination thereof.

Preferably, the halogen-containing gas includes one of HCl, BCl₃, Cl₂, a gas mixture of H₂/Cl₂, HBr or any combination thereof.

Preferably, the cleaning gas includes one of a gas mixture of H₂/Cl₂/CO₂, a gas mixture of H₂/Cl₂/O₂, a gas mixture of HCl/O₂, a gas mixture of HCl/CO₂, a gas mixture of BCl₃/O₂ or any combination thereof.

Preferably, the predetermined pressure range is 0.1 Torr to 10 Torr, and the predetermined time period is longer than 3 minutes.

Furthermore, the present invention further provides another method for in situ cleaning of an MOCVD reaction chamber, including:

introducing a cleaning gas into the MOCVD reaction chamber, wherein the cleaning gas includes an oxygen-containing gas and a halogen-containing gas;

maintaining an internal pressure of the MOCVD reaction chamber in a predetermined pressure range, and keeping an internal temperature of the MOCVD reaction chamber in a range of 200° C.-500° C. for a predetermined time period to completely remove deposits inside the MOCVD reaction chamber.

Preferably, the cleaning gas further includes Ar.

Preferably, the oxygen-containing gas includes one of O₂, O₃, CO₂, CO, H₂O₂, N₂O or any combination thereof.

Preferably, the halogen-containing gas includes one of HCl, BCl₃, Cl₂, a gas mixture of H₂/Cl₂, HBr or any combination thereof.

Preferably, the cleaning gas includes one of a gas mixture of H₂/Cl₂/CO₂, a gas mixture of H₂/Cl₂/O₂, a gas mixture of HCl/O₂, a gas mixture of HCl/CO₂, a gas mixture of BCl₃/O₂ or any combination thereof.

Preferably, the predetermined pressure range is 0.1 Torr to 10 Torr, and the predetermined time period is longer than 3 minutes.

In embodiments of the present invention, the cleaning gas including the oxygen-containing gas and the halogen-containing gas and/or the plasma converted from the cleaning gas are adopted to react with the deposits inside the MOCVD reaction chamber, to convert the carbonaceous organic substances and the metal and its compound(s) into gaseous carbonaceous compounds and gaseous metal compound(s), which are discharged through a gas exhausting device of the MOCVD reaction chamber, thereby the deposits are completely removed from the MOCVD reaction chamber. The method for in situ cleaning of an MOCVD reaction chamber according to the embodiments of the invention may remove the relatively steady organic ligands or related polymers and the metal and its compound(s), resulting in a good cleaning effect for the removal of the deposits on the surface with a relatively low temperature inside the reaction chamber.

### BRIEF DESCRIPTION OF THE DRAWINGS

The drawings used in the description of the embodiments or the prior art will be described briefly as follows, so that the technical solutions according to the embodiments of the present invention or according to the prior art will become clearer. Like reference numerals refer to like components in the drawings. It is obvious that the drawings in the following description are only some embodiments of the present invention. For those skilled in the art, other drawings may be obtained according to these drawings without any creative work. In the drawings, the same reference numerals indicate the same parts. The drawings may not be drawn to scale, so as not to unnecessarily obscure the essential of the present invention.

FIG. 1 is a flowchart of the method for in situ cleaning of an MOCVD reaction chamber according to a first embodiment of the present invention;

FIG. 2 is a schematic structural diagram of an MOCVD reaction chamber according embodiments of the present invention;

FIG. 3 is a flowchart of the method for in situ cleaning of an MOCVD reaction chamber according to a second embodiment of the present invention; and

FIG. 4 is a flowchart of the method for in situ cleaning of an MOCVD reaction chamber according to a third embodiment of the present invention.

### DETAILED DESCRIPTION OF THE INVENTION

In order to make the purpose, technique solution and advantages of the embodiments of the invention to be clearer, the technical solution according to the embodiments of the present invention will be described clearly and completely as follows in conjunction with the drawings. It is obvious that the described embodiments are only some of the embodiments according to the present invention. All the other embodiments obtained by those skilled in the art based on the embodiments in the present invention without any creative work belong to the scope of protection of the present invention.

In order to solve the problem in the prior art that deposits on surfaces with a relatively low temperature inside an MOCVD reaction chamber can not be removed effectively, a method for in situ cleaning of an MOCVD reaction chamber is proposed by the inventors after research, which will be described in detail as follows.

### First Embodiment

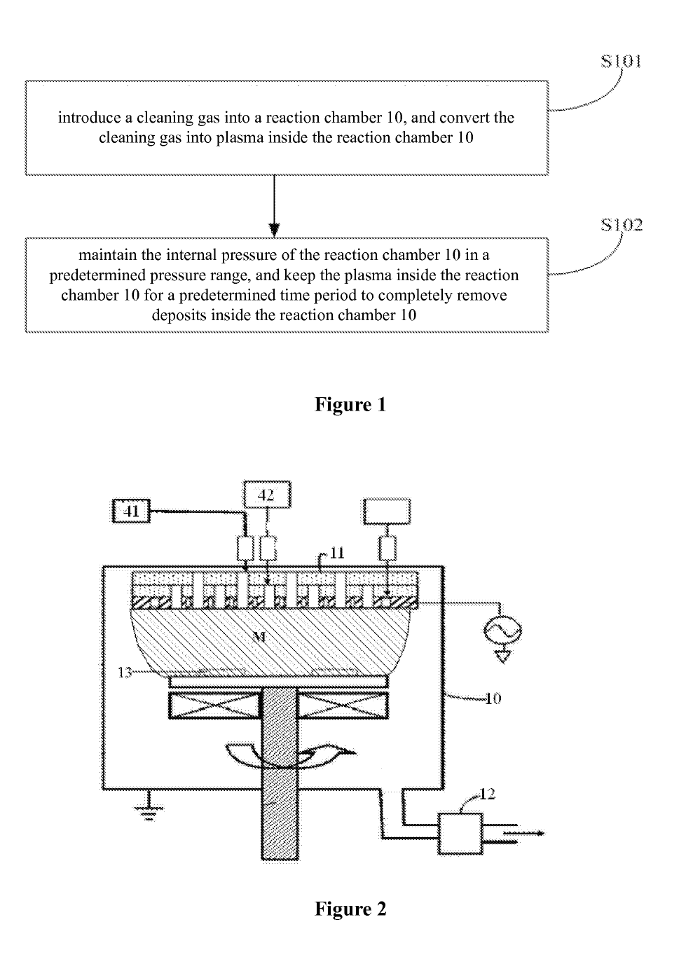

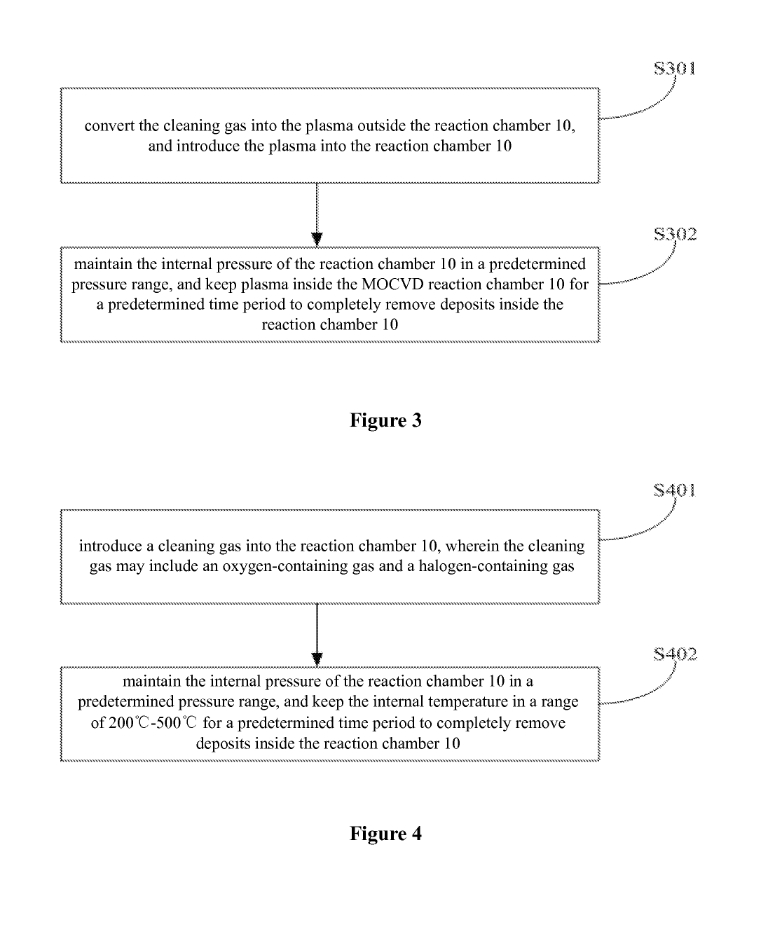

FIG. 1 shows a flowchart of the method for in situ cleaning of an MOCVD reaction chamber according to a first embodiment. The method is described in detail as follows in conjunction with a schematic structural diagram of the MOCVD reaction chamber (i.e., FIG. 2).

Step S101: introducing a cleaning gas into a reaction chamber 10, and converting the cleaning gas into plasma inside the reaction chamber 10.

The cleaning gas according to the first embodiment may include an oxygen-containing gas and a halogen-containing gas. In the case that the cleaning gas includes only two types of gases, the two types of gases may be introduced into the reaction chamber 10 through two intake ducts (for example, intake ducts 41 and 42). In the case that the cleaning gas includes multiple types of gases, the multiple types of gases may be introduced into the reaction chamber 10 through multiple intake ducts to ensure that the multiple types of gases are introduced into the reaction chamber 10 separately, that is, the multiple types of gases may not be mixed until entering into the reaction chamber 10. Furthermore, the cleaning gas may also be mixed before entering into the reaction chamber 10, and then be introduced into the reaction chamber 10 through the intake duct 41 or 42.

The oxygen-containing gas in the first embodiment may include but not limited to one of O₂, CO₂, CO, H₂O₂, N₂O or any combination thereof. The halogen-containing gas in the first embodiment may include but not limited to one of HCl, BCl₃, Cl₂, a gas mixture of H₂/Cl₂ (in the application, “a gas mixture of H₂/Cl₂” means “a gas mixture of H₂ and Cl₂”, other similar description means similarly), HBr or any combination thereof. Specifically, the cleaning gas in the first embodiment may be one of a gas mixture of H₂/Cl₂/CO₂, a gas mixture of H₂/Cl₂/O₂, a gas mixture of HCl/O₂, a gas mixture of HCl/CO₂, a gas mixture of BCl₃/O₂ or any combination thereof. Furthermore, in order to further improve the cleaning effect and the cleaning speed, in this step, a second cleaning gas may include an appropriate amount of Ar. Inside the reaction chamber 10, Ar may be converted into Ar plasma, which may accelerate the reaction.

According to the first embodiment, the cleaning gas is converted into plasma after entering into the reaction chamber 10. Specifically, it is possible to apply an RF (Radio Frequency) voltage with a certain power between a shower head 11 and a susceptor 13 of the reaction chamber 10, such that the cleaning gas is converted into plasma through the RF voltage in a reaction region M inside the reaction chamber 10 (for example, the reaction region may be the region between the shower head 11 and the susceptor 13, in which the susceptor 13 is configured to place substrates to be processed for preparing a compound of Group III element(s) and Group V element(s)). Furthermore, the cleaning gas may be converted into plasma in the region inside the reaction chamber 10 other than the reaction region. Specifically, it is possible to apply an RF voltage with a certain power between an inner wall of the reaction chamber 10 and the susceptor 13 or between an inner wall of the reaction chamber 10 and the shower head 11, such that the cleaning gas is converted into plasma through the RF voltage in the region other than the reaction region M (in FIG. 2, the region inside the reaction chamber 10 other than the reaction region M). Certainly, the way to convert the cleaning gas into plasma in the first embodiment is not limited to the above two ways, and may include other common ways in the field, which will not be listed herein.

Step S102: maintaining the internal pressure of the reaction chamber 10 in a predetermined pressure range, and keeping the plasma inside the reaction chamber 10 for a predetermined time period to completely remove deposits inside the reaction chamber 10.

After the cleaning gas is converted into plasma inside the reaction chamber 10, the internal pressure of the reaction chamber is maintained in a predetermined pressure range (0.1 Torr to 10 Torr, for example) for a predetermined time period (longer than 3 minutes, for example), so as to enable the cleaning process (i.e., the process for removing the carbonaceous organic substances and the metal and its compound(s) inside the reaction chamber) to be performed adequately. For example, the internal pressure of the reaction chamber may be maintained in a range of 0.1 Torr to 1 Torr for 5 minutes to 30 minutes. Those skilled in the art may properly choose an internal pressure of the reaction chamber and a reaction time period according to a practical cleaning requirement, which will not be listed herein.

During the cleaning procedure, a gas exhausting device 12 may be controlled to be always in a open state, so that, on one hand, the gas generated after the reaction between the plasma and the deposits inside the reaction chamber 10 may be discharged continuously from the reaction chamber 10 to accelerate the cleaning process and to improve the cleaning effect; on the other hand, the internal pressure of the reaction chamber 10 may be maintained at a certain level to meet the requirement of the cleaning process. That is, according to the first embodiment, the internal pressure of the reaction chamber 10 may be controlled by controlling the degree of opening of the gas exhausting device 12, i.e., by controlling the gas displacement of the gas exhausting device 12.

Furthermore, in order to improve the cleaning effect and the cleaning speed, the cleaning gas may include a certain amount of Ar in this step. Inside the reaction chamber 10, Ar may be converted into Ar plasma, which may accelerate the cleaning reaction (that is, the reaction between the plasma and the deposits inside the reaction chamber).

For example, after the cleaning gas is converted into plasma, the internal pressure of the reaction chamber is maintained in a range of 0.1 Torr to 1 Torr (as an example of the predetermined pressure range) for more than 3 minutes (as an example of the predetermined time period), so the plasma and the deposits inside the reaction chamber are reacted adequately. The “predetermined time period” in the embodiments of the present invention may be, for example, 5 minutes, 20 minutes, 30 minutes and the like. Those skilled in the art may adjust the length of the “predetermined time period” according to a specific requirement of cleaning, which will not be limited in the embodiments of the present invention. Furthermore, those skilled in the art may also properly choose the internal pressure of the reaction chamber and the flow rate according to a specific requirement of cleaning, which will not be listed herein.

After the cleaning gas including the oxygen-containing gas and the halogen-containing gas is converted into plasma, the plasma includes at least oxygen and halogen, and oxygen ions and halogen ions. In this step, the oxygen and the halogen in the plasma are mainly employed to react with the carbonaceous organic substances and the metal and its compound(s) so as to generate gaseous carbonaceous compounds and gaseous metal halide, which are finally discharged from the reaction chamber 10 through the gas exhausting device 12. Specifically, the oxygen can react with the carbonaceous organic substances in the deposits to generate gaseous oxycarbides, and the halogen can react with the metal and its compound(s) to generate the gaseous metal halide.

By the method for in situ cleaning of an MOCVD reaction chamber according to the embodiment of the invention, the cleaning gas is introduced into the reaction chamber and is converted into plasma in the reaction chamber. Under an appropriate condition of temperature and pressure, the plasma may break the carbon bond in the carbonaceous organic substances or carbonaceous polymers, leading to a reaction to generate carbonaceous gas or carbonaceous halide(s), which are then discharged from the reaction chamber by a certain way. Therefore, the relatively stable organic ligand and related polymer are converted into substances which have a higher activity and are easy to be removed. The thus obtained substances may be discharged from the reaction chamber with a gas flow under a certain condition of flow rate, pressure and temperature, so as to achieve the purpose of cleaning The method for in situ cleaning of an MOCVD reaction chamber according to the embodiment of the invention may remove the relatively stable organic ligand or related polymer, resulting in a good cleaning effect for the removal of the deposits on the surfaces with a relatively low temperature inside the reaction chamber.

It should be noted that, each of the Step S101 and Step S102 of the first embodiment may be performed only once, that is, the deposits inside the reaction chamber may be removed in one-step. Alternatively, Step S101 and Step S102 of the first embodiment may be repeated to further improve the cleaning effect.

The technique solution of the first embodiment will be described in detail by a specific example as follows.

O₂, Cl₂ and Ar are introduced into the reaction chamber 10 simultaneously. Specifically, O₂, Cl₂ and Ar may be introduced respectively into the reaction chamber 10 through the intake ducts shown in FIG. 2 at respective flow rate of 250 sccm, 500 sccm and 500 sccm. A RF voltage is applied between the shower head 11 and the inner wall of the reaction chamber 10 with a power of 2000 W and an RF frequency of 13.56 MHz. The internal pressure of the reaction chamber 10 is kept to be 0.72 Torr, and the reaction time period of the plasma is 10 minutes (i.e., the predetermined time period is 10 minutes). After this step, most of the deposits inside the reaction chamber 10 are removed.

In the first embodiment, on one hand, an oxygen-containing component in the cleaning gas is employed to react with the carbonaceous organic substances in the deposits, to convert the carbonaceous organic substances in the deposits into gaseous carbonaceous compounds, which are then discharged from the reaction chamber 10 through the gas exhausting device 12. For example, the oxygen ions in the plasma may react with the carbonaceous organic substances to generate gaseous oxycarbides, which may be discharged from the reaction chamber 10 through the gas exhausting device 12, thereby the carbonaceous organic substances inside the reaction chamber 10 may be removed. On the other hand, the halogen which is converted into plasma is employed to react with the residual metal and its compound(s) inside the reaction chamber, to convert the residual metal and its compound(s) into a gaseous metal halide, which may be then discharged from the reaction chamber 10. For example, metal and its compound(s) such as Ga, In, Al, GaN, InN and AN which are generally left inside the MOCVD reaction chamber may react with the plasma of the halogen-containing gas (Cl₂, for example) inside the reaction chamber 10, to generate gaseous GaCl₃, InCl₃, AlCl₃ and so on, which may be discharged from the reaction chamber 10 through the gas exhausting device 12, thereby the metal and its compound(s) inside the reaction chamber 10 may be removed.

In removing the deposits (especially, deposits on the surfaces with a relatively low temperature) inside the MOCVD reaction chamber by the method for in situ cleaning according to the first embodiment, a stable process and improved performance may be achieved and the whole MOCVD process can be performed automatically.

It should be noted that, in the first embodiment, the reaction chamber 10 may be heated to maintain a certain internal temperature of the reaction chamber 10 during the process for in situ cleaning of the MOCVD reaction chamber (Step S101 and Step S102, for example). In this way, it is possible not only to increase the speed of the in situ cleaning, but also to ensure that the by-product of the reaction between the plasma and the deposit is gaseous and to avoid that the gaseous by product becomes liquid or solid when contacting with the surface with a relatively low temperature and thus is left inside the reaction chamber. For example, the internal temperature of the reaction chamber 10 may be maintained in a range of 70° C.-100° C. (for example, 70° C., 80° C. or 100° C.). Specifically, the outer wall or the inner wall of the reaction chamber may be heated to maintain the internal temperature of the reaction chamber.

In the method for in situ cleaning of an MOCVD reaction chamber according to the first embodiment, by introducing a cleaning gas into the reaction chamber, converting the cleaning gas into plasma inside the reaction chamber, making the plasma react with the deposits inside the reaction chamber to generate gaseous product, and then discharging the gaseous product from the reaction chamber through a gas exhausting device, the purpose for in situ cleaning of the MOCVD reaction chamber is achieved. It should be noted that, the plasma may be generated inside the reaction chamber; alternatively, the plasma may be generated outside the reaction chamber and then be introduced into the reaction chamber.

### Second Embodiment

The method for in situ cleaning of an MOCVD reaction chamber of the second embodiment is similar to that of the first embodiment. The difference lies in that, in the second embodiment, the plasma is generated outside the reaction chamber and then introduced into the reaction chamber through an intake duct. For succinctness, only the difference of the second embodiment from the first embodiment will be described. It is easy for those skilled in the art to obtain other contents of the second embodiment from the related description in the first embodiment, which will not be repeated here.

Step S301: converting the cleaning gas into plasma outside the reaction chamber 10, and introducing the plasma into the reaction chamber 10, wherein the cleaning gas includes an oxygen-containing gas and a halogen-containing gas.

Specifically, the plasma may be generated by a plasma converting device. For example, the cleaning gas may firstly be introduced into the plasma converting device and then be converted into plasma inside the plasma converting device.

The oxygen-containing gas in the second embodiment may include but not limited to one of O₂, CO₂, CO, H₂O₂, N₂O or any combination thereof. The halogen-containing gas in the second embodiment may include but not limited to one of HCl, BCl₃, Cl₂, a gas mixture of H₂/Cl₂, HBr or any combination thereof. Furthermore, in order to further improve the effect and speed of cleaning, the cleaning gas may include an appropriate amount of Ar in this step. Inside the reaction chamber 10, Ar may be converted into Ar plasma, which may accelerate the reaction.

Step S302: maintaining the internal pressure of the reaction chamber 10 in a predetermined pressure range, and keeping the plasma inside the MOCVD reaction chamber 10 for a predetermined time period to completely remove deposits inside the reaction chamber 10.

After the plasma is introduced into the reaction chamber 10, the internal pressure of the reaction chamber 10 may be maintained in a range of 0.1 Torr to 10 Torr (as an example of the predetermined pressure range) for more than 3 minutes (5 minutes to 30 minutes, for example), so the plasma reacts with the residual metal and its compound(s) in the deposits adequately to generate a gaseous metal halide, which is then discharged from the reaction chamber through the gas exhausting device.

The cleaning gas in the second embodiment has the same meaning as that in the first embodiment, in which the expression of “has the same meaning” means that the cleaning gas in the second embodiment has the same range as that in the first embodiment (for example, they both include an oxygen-containing gas and a halogen-containing gas). However, any different kind of gas in this range may be selected. The expression of “has the same meaning” in the following means similarly.

Furthermore, in order to improve the cleaning effect and the cleaning speed, the cleaning gas may include a certain amount of Ar in this step. Inside the reaction chamber 10, Ar may be converted into Ar plasma, which may accelerate the cleaning reaction (that is, the reaction between the plasma of the cleaning gas and the deposits inside the reaction chamber).

In the second embodiment, the reaction chamber 10 may be heated to maintain a certain internal temperature of the reaction chamber 10 during the process for in situ cleaning of the MOCVD reaction chamber (Step S301 and Step S302, for example). In this way, it is possible not only to increase the speed of the in situ cleaning, but also to ensure that the product of the reaction between the plasma and the deposit is gaseous and to avoid that the gaseous product becomes liquid or solid when contacting with the surfaces with a relatively low temperature and thus is left inside the reaction chamber. For example, the internal temperature of the reaction chamber 10 may be maintained in a range of 70° C.-100° C. (for example, 70° C., 80° C. or 100° C.). Specifically, the outer wall or the inner wall of the reaction chamber may be heated to maintain the internal temperature of the reaction chamber.

In the second embodiment, the plasma converted from the cleaning gas including an oxygen-containing gas and a halogen-containing gas is adopted to react with the deposits inside the MOCVD reaction chamber, so as to convert the carbonaceous organic substances and the metal and its compound(s) in the deposits into gaseous carbonaceous compounds and gaseous metal compounds, which are then discharged through a gas exhausting device of the MOCVD reaction chamber, thereby the deposits are completely removed from the MOCVD reaction chamber. The method for in situ cleaning of an MOCVD reaction chamber according to the embodiment of the invention may remove the relatively stable organic ligand or related polymer and the metal and its compound(s), resulting in a good cleaning effect for the removal of the deposits on the surface with a relatively low temperature inside the reaction chamber.

It should be noted that, the description of parameters (pressure, time period, temperature and the like, for example), composition and content of the gas and the like in the first embodiment is also applicable to the solution in the second embodiment, which will not be repeated here for succinctness. However, by combining the solution in the second embodiment with the corresponding content in the first embodiment, the skilled in the art may obtain a specific implementation, which is still within the scope of protection of the present invention.

In the first and the second embodiments, it is mainly described that the plasma (the first plasma and/or second plasma) is adopt to remove the deposits (carbonaceous organic substances and/or metal and its compound(s)) inside the reaction chamber. In fact, in embodiments of the present invention, the deposits inside the reaction chamber may also be removed by the thermal reaction of the cleaning gas with the deposits.

### Third Embodiment

The method for in situ cleaning of an MOCVD reaction chamber of the third embodiment is similar to that of the first embodiment. The difference lies in that, in the third embodiment, a cleaning gas is employed to have a thermal reaction with the deposits inside the reaction chamber to remove the deposits. For succinctness, only the difference of the third embodiment from the first embodiment will be described. It is easy for those skilled in the art to obtain other contents of the third embodiment from the related description in the first embodiment, which will not be repeated here.

Step S401: introducing a cleaning gas into the reaction chamber 10, wherein the cleaning gas may include an oxygen-containing gas and a halogen-containing gas.

In the case that the cleaning gas includes only two types of gases, the two types of gases may be introduced into the reaction chamber 10 through two intake ducts (for example, intake ducts 41 and 42). In the case that the cleaning gas includes multiple types of gases, the multiple types of gases may be introduced into the reaction chamber 10 through multiple intake ducts to ensure that the multiple types of gases are introduced into the reaction chamber 10 separately, that is, the multiple types of gases may not be mixed until entering into the reaction chamber 10. Alternatively, the cleaning gas may be mixed before entering into the reaction chamber 10, and then be introduced into the reaction chamber 10 through the intake duct 41 or 42.

The oxygen-containing gas in the third embodiment may include but not limited to one of O₂, CO₂, CO, H₂O₂, N₂O or any combination thereof. The halogen-containing gas in the third embodiment may include but not limited to one of HCl, BCl₃, Cl₂, a gas mixture of H₂/Cl₂, HBr or any combination thereof. Specifically, the cleaning gas in the third embodiment may be one of a gas mixture of H₂/Cl₂/CO₂, a gas mixture of H₂/Cl₂/O₂, a gas mixture of HCl/O₂, a gas mixture of HCl/CO₂, a gas mixture of BCl₃/O₂ or any combination thereof. Furthermore, in order to further improve the cleaning effect and the cleaning speed, the cleaning gas may further include an appropriate amount of Ar in this step.

Step S402: maintaining the internal pressure of the reaction chamber 10 in a predetermined pressure range, and keeping the internal temperature of the reaction chamber 10 in a range of 200° C.-500° C. for a predetermined time period to completely remove deposits inside the reaction chamber 10.

In this step, under a high temperature (200° C.-500° C.), a thermal reaction between the cleaning gas inside the reaction chamber 10 with the deposits occurs to convert the solid deposits into gaseous product, which is then discharged from the reaction chamber 10, thereby the purpose for in situ cleaning of the MOCVD reaction chamber is achieved. Specifically, the oxygen-containing component in the cleaning gas may react with the carbonaceous organic substances in the deposits, to generate gaseous carbonaceous compounds. Moreover, the halogen-containing component in the cleaning gas may react with the residual metal and its compound(s) in the deposits, to generate gaseous metal halide. For example, metal such as Ga, In, Al, GaN, InN and AN and its compound(s) which are generally prone to be left inside the MOCVD reaction chamber may react with the plasma of the halogen-containing gas (Cl₂, for example) inside the reaction chamber 10 to generate gaseous GaCl₃, InCl₃, AlCl₃ and so on, which may be then discharged from the reaction chamber 10 through the gas exhausting device 12, thereby the metal and its compound(s) inside the reaction chamber 10 may be removed.

In the third embodiment, the cleaning gas including the oxygen-containing gas and the halogen-containing gas is employed to have a thermal reaction with the deposits inside the reaction chamber, so as to convert the carbonaceous organic substances and the metal and its compound(s) in the deposits into gaseous carbonaceous compounds and gaseous metal compound, which are then discharged through a gas exhausting device of the reaction chamber, thereby the deposits are completely removed from the reaction chamber. The method for in situ cleaning of an MOCVD reaction chamber according to the embodiment of the invention may remove the relatively stable organic ligands or related polymers and the metal and its compound(s), resulting in a good cleaning effect for the removal of the deposits on the surfaces with a relatively low temperature inside the reaction chamber.

It should be noted that, the description of parameters (pressure, time period, temperature and the like, for example), composition and content of the gas and the like in the first and/or second embodiment is also applicable to the solution in the third embodiment, which will not be repeated here for succinctness. However, by combining the solution in the third embodiment with the corresponding content in the first and/or second embodiment, the skilled in the art may obtain a specific implementation, which is still within the scope of protection of the present invention.

Thus, in the embodiments of the invention, the deposits inside the reaction chamber may be removed by the thermal reaction of the cleaning gas with the deposits. Moreover, the deposits inside the reaction chamber may also be removed by firstly converting the cleaning gas into plasma and then making the plasma react with the deposits. The plasma may be generated outside the reaction chamber, or may be generated inside the reaction chamber (may be generated in the reaction region inside the reaction chamber, or may be generated in the region inside the reaction chamber other than the reaction region). Furthermore, by using the solution in the above-mentioned embodiments of the invention, the carbonaceous organic substances and the metal and its compound(s) in the deposits inside the reaction chamber may be removed completely by only one step.

Preferable embodiments of the present invention are described above. It should be noted that several improvements and modifications could be made by those skilled in the art without departing from the principle of the present invention, which shall fall in the scope of protection of the present invention.

1. A method for in situ cleaning of a Metal-Organic Chemical Vapor Deposition reaction chamber, comprising:
maintaining an internal pressure of the reaction chamber in a predetermined pressure range, and keeping a plasma inside the reaction chamber for a predetermined time period to completely remove deposits inside the reaction chamber, wherein the plasma is generated by the following steps:
introducing a cleaning gas into the reaction chamber, and converting the cleaning gas into the plasma inside the reaction chamber; and/or
converting the cleaning gas into the plasma outside the reaction chamber, and introducing the plasma into the reaction chamber;
wherein the cleaning gas comprises an oxygen-containing gas and a halogen-containing gas.

2. The method according to claim 1, wherein the cleaning gas further comprises Ar.

3. The method according to claim 1, further comprising:
during the predetermined time period, heating the reaction chamber such that an internal temperature of the reaction chamber is maintained in a range of 70° C. to 80° C.

4. The method according to claim 1, wherein the oxygen-containing gas comprises one of O₂, O₃, CO₂, CO, H₂O₂, N₂O or any combination thereof

5. The method according to claim 1, wherein the halogen-containing gas comprises one of HCl, BCl₃, Cl₂, a gas mixture of H₂/Cl₂, HBr or any combination thereof

6. The method according to claim 1, wherein the cleaning gas comprises one of a gas mixture of H₂/Cl₂/CO₂, a gas mixture of H₂/Cl₂/O₂, a gas mixture of HCl/O₂, a gas mixture of HCl/CO₂, a gas mixture of BCl₃/O₂ or any combination thereof.

7. The method according to claim 1, wherein the predetermined pressure range is 0.1 Torr to 10 Torr, and the predetermined time period is longer than 3 minutes.

8. A method for in situ cleaning of an MOCVD reaction chamber, comprising:
introducing a cleaning gas into the reaction chamber, wherein the cleaning gas comprises an oxygen-containing gas and a halogen-containing gas; and
maintaining an internal pressure of the reaction chamber in a predetermined pressure range, and keeping an internal temperature of the reaction chamber in a range of 200° C.-500° C. for a predetermined time period to completely remove deposits inside the reaction chamber.

9. The method according to claim 8, wherein the cleaning gas further comprises Ar.

10. The method according to claim 8, wherein the oxygen-containing gas comprises one of O₂, O₃, CO₂, CO, H₂O₂, N₂O or any combination thereof

11. The method according to claim 8, wherein the halogen-containing gas comprises one of HCl, BCl₃, Cl₂, a gas mixture of H₂/Cl₂, HBr or any combination thereof

12. The method according to claim 8, wherein the cleaning gas comprises one of a gas mixture of H₂/Cl₂/CO₂, a gas mixture of H₂/Cl₂/O₂, a gas mixture of HCl/O₂, a gas mixture of HCl/CO₂, a gas mixture of BCl₃/O₂ or any combination thereof.

13. The method according to claim 8, wherein the predetermined pressure range is 0.1 Torr to 10 Torr, and the predetermined time period is longer than 3 minutes.
